(19) United States
(12) Patent Application Publication
(10) Pub. No.: US 2016/0172835 A1
(43) Pub. Date: Jun. 16, 2016

(54) POWER CABLE POLYMER JOINT

(71) Applicant: Hitachi Metals, Ltd., Tokyo (JP)

(72) Inventors: Yukinori AISHIMA, lshioka (JP); Wataru MURATA, Hitachi (JP)

(21) Appl. No.: 14/965,581

(22) Filed: Dec. 10, 2015

(30) Foreign Application Priority Data
Dec. 12, 2014 (JP) 2014-251553

(51) Int. Cl. H02G 15/013; H01B 3/30

(52) U.S. Cl. CPC H02G 15/013; H01B 3/30

(57) ABSTRACT

A power cable polymer joint includes a polymer protective layer including a cable insertion hole into which a stripped end of a power cable is inserted. The polymer protective layer includes an insulation including a polymer-based material, a semi-conductive portion including mainly a polymer-based material to relax an electric field at the end of the power cable, and a tubular member including a different material from the polymer-based material and extending on a rear-end side of the insulation and the semi-conductive portion. The insulation and the semi-conductive portion and the tubular member are integrally formed.

### The present application is based on Japanese patent application No. 2014-251553 filed on Dec. 12, 2014, the entire contents of which are incorporated herein by reference.

### BACKGROUND OF THE INVENTION

1. Field of Invention

The invention relates to a power cable polymer joint using a polymer protective layer.

2. Description of the Related Art

A terminal joint to be directly connected to equipment has been proposed which is constructed such that a penetrating portion leading to an equipment is formed using a hard insulator such as an epoxy bushing to ensure long-term airtightness or oil tightness, and a stress cone and a mechanism to compress the stress cone are provided on the side of a cable so as to relax an electric field (see e.g., JP-A-H07-170643).

The terminal joint to be directly connected to equipment is provided with the epoxy bushing into which an end of the cable is inserted, the stress cone inserted inside the epoxy bushing, a compressor device for compressing the stress cone toward the cable, a protective metal fitting covering a sheath of the cable, and a waterproof tape layer formed between the protective metal fitting and the sheath of the cable by winding a waterproof tape.

### SUMMARY OF THE INVENTION

Since the terminal joint is constructed such that the protective metal fitting is attached to the insulation layer (or sheath), the entire weight increases due to an increase in the number of components so that the connection workload of the terminal joint to the equipment increases.

It is an object of the invention to provide a power cable polymer joint that is lightened as well as having improved easiness of waterproofing.

According to an embodiment of the invention, a power cable polymer joint comprises a polymer protective layer comprising a cable insertion hole into which a stripped end of a power cable is inserted,
wherein the polymer protective layer comprises:
an insulation comprising a polymer-based material;
a semi-conductive portion comprising mainly a polymer-based material to relax an electric field at the end of the power cable; and
a tubular member comprising a different material from the polymer-based material and extending on a rear-end side of the insulation and the semi-conductive portion, and
wherein the insulation and the semi-conductive portion and the tubular member are integrally formed.

In the above embodiment, the end of the power cable may be directly connected to equipment.

### EFFECTS OF THE INVENTION

According to an embodiment of the invention, a power cable polymer joint can be provided that is lightened as well as having improved easiness of waterproofing.

### BRIEF DESCRIPTION OF THE DRAWINGS

Next, the present invention will be explained in more detail in conjunction with appended drawings, wherein:

FIG. 1 is a longitudinal cross-sectional view showing a configuration example of a power cable polymer terminal joint in an embodiment of the present invention; and

FIG. 2 is a lateral cross-sectional view showing a power cable shown in FIG. 1.

### DETAILED DESCRIPTION OF THE PREFERRED EMBODIMENTS

An embodiment of the invention will be described below in reference to the drawings. Constituent elements having substantially the same functions are denoted by the same reference numerals in each drawing and the overlapping explanation thereof will be omitted.

### Embodiment

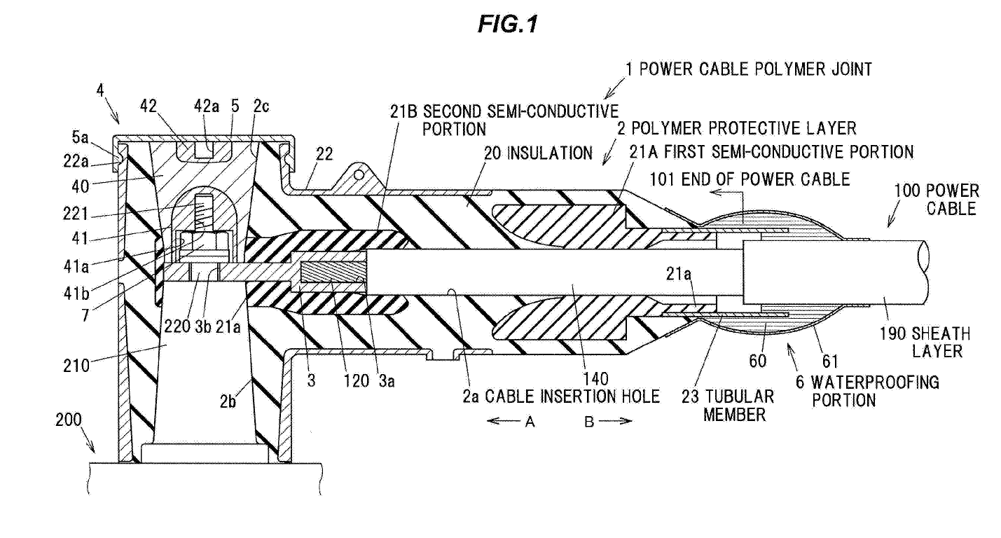

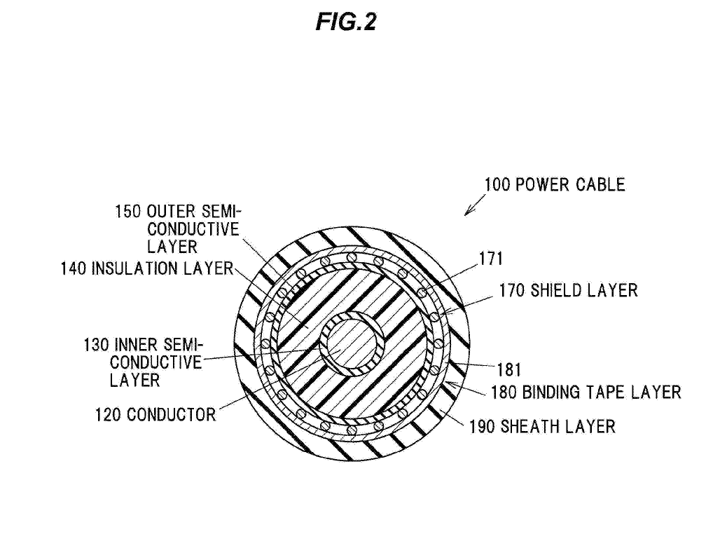

FIG. 1 is a longitudinal cross-sectional view showing a configuration example of a power cable polymer joint in the embodiment of the invention which is connected to an equipment. FIG. 2 is a lateral cross-sectional view showing a power cable shown in FIG. 1.

### Configuration of Power Cable Polymer Joint

A power cable polymer joint 1 is a terminal joint to be directly connected to equipment, is formed mainly of a polymer-based material (an insulating polymer material), and is provided with a polymer protective layer 2 having a cable insertion hole 2a for insertion of a stripped end 101 of a power cable 100, a compression terminal 3 connected to a conductor 120 of the power cable 100, an insulating plug 4 connecting the compression terminal 3 to an equipment-side conductor 220 of an equipment 200, a protective cap 5 for protecting the insulating plug 4, and a waterproofing portion 6 for sealing a rear-end side B of the polymer protective layer 2.

### Configuration of Equipment

The power cable polymer joint 1 is applicable to, e.g., the equipment 200 such as transformer or gas-insulated switchgear. The equipment 200 is provided with an equipment-side bushing 210 having a tapered shape and the equipment-side conductor 220 exposed from the equipment-side bushing 210. A male screw 221 is formed at a tip of the equipment-side conductor 220.

### Configuration of Polymer Protective Layer

The polymer protective layer 2 is provided with an insulation 20 formed of a polymer-based material, a first semi-conductive portion 21A for relaxing an electric field at the end 101 of the power cable 100, a second semi-conductive portion 21B for relaxing an electric field at the compression terminal 3, a protective cover 22 for protecting a front-end side A of the insulation 20, and a tubular member 23 provided on the rear-end side B of the insulation 20. The insulation 20, the first and second semi-conductive portions 21A and 21B, the protective cover 22 and the tubular member 23, which constitute the polymer protective layer 2, are integrally formed using a mold in a factory.

The polymer protective layer 2 also has a bushing insertion hole 2b for insertion of the equipment-side bushing 210 and an insulating plug insertion hole 2c for insertion of the insulating plug 4.

The polymer-based material for forming the insulation 20 is, e.g., a silicone rubber, an ethylene-propylene rubber (EPM) or an ethylene-propylene-diene rubber (EPDM), etc.

The first and second semi-conductive portions 21A and 21B are formed mainly of a polymer-based material. In detail, the first and second semi-conductive portions 21A and 21B are formed by extruding a polymer-based material which is obtained by, e.g., dispersing conductive powder such as carbon in a silicone rubber, EMP or EPDM, etc., and thus has conductivity.

A hole 21a having an inner diameter larger than an outer diameter of an insulation layer 140 is formed in the first semi-conductive portion 21A in a region overlapping with the tubular member 23 in the cable axis direction. If the hole 21a is not formed, it is difficult to insert the power cable 100 into the cable insertion hole 2a since the tubular member 23 formed of a metal restricts expansion of the inner diameter of the first semi-conductive portion 21A. In the present embodiment, since the hole 21a is formed, it is easy to insert the power cable 100 into the cable insertion hole 2a.

The protective cover 22 is formed of, e.g., a metal such as brass or aluminum alloy. A recess 22a to be engaged with a protrusion 5a (described later) of the protective cap 5 is formed on an outer peripheral surface of the protective cover 22. Thus, when pushing down the protective cap 5 toward the equipment 200, the protrusion 5a of the protective cap 5 is engaged with the recess 22a of the protective cover 22 and the protective cap 5 is thereby fixed to the protective cover 22.

The tubular member 23 is formed of a different material from the polymer-based material, in other words, formed of a material having good adhesion to a waterproof tape 60 used to form the waterproofing portion 6, e.g., a metal such as brass or aluminum alloy. When the metal tubular member 23 is not provided and the insulation 20 is formed of, e.g., a silicone rubber, it is difficult to waterproof between the insulation 20 and a sheath layer 190 of the power cable 100 by the waterproof tape 60 since adhesion between the waterproof tape 60 and the silicone rubber insulation 20 is poor. Therefore, the metal tubular member 23 is employed in the present embodiment. In addition, the tubular member 23 has an inner diameter larger than an outer diameter of the non-stripped power cable 100, i.e., an outer diameter of the sheath layer 190.

The tubular member 23 is provided on the outermost side of the first semi-conductive portion 21A in the present embodiment, but may be provided inside or the innermost side of the first semi-conductive portion 21A. In addition, an end portion of the tubular member 23 on the front-end side A is exemplarily chamfered to relax electric field concentration. Plating may be additionally provided on the tubular member 23 to suppress discoloration due to heat during molding of the polymer protective layer 2.

### Other Configuration

The compression terminal 3 has a crimp hole 3a on the rear-end side B and an equipment connection hole 3b on the front-end side A. After inserting the conductor 120 of the power cable 100 into the crimp hole 3a of the compression terminal 3, the diameter of the crimp hole 3a is reduced by crimping the compression terminal 3 on the rear-end side B and the conductor 120 of the power cable 100 is thereby connected to the compression terminal 3.

The insulating plug 4 is provided with an insulation 40, a high-voltage electrode 41 provided on one end of the insulation 40, and a voltage detection electrode 42 provided on the other end of the insulation 40. The high-voltage electrode 41 has a counterbore hole 41a corresponding to a shape of a nut 7 and a female screw 41b screwed together with the male screw 221 of the equipment-side conductor 220. The voltage detection electrode 42 has a square hole 42a to which a driver head of a socket wrench is fitted. The insulation 40, the high-voltage electrode 41 and the voltage detection electrode 42, which constitute the insulating plug 4, are integrally formed using a mold in a factory.

The protective cap 5 is formed of, e.g., a metal such as brass or aluminum alloy. The protrusion 5a to be engaged with the recess 22a of the protective cover 22 is formed on an inner peripheral surface of the protective cap 5.

The waterproofing portion 6 is formed by winding a good water-resistant member, e.g., the waterproof tape 60 such as polyethylene or epoxy tape with an adhesive layer and then providing a heat shrinkable tube 61 thereon. Alternatively, the waterproofing portion 6 may be formed using another method other than using the waterproof tape 60. (Configuration of power cable)

The power cable 100 is composed of the conductor 120 formed of a twisted wire, an inner semi-conductive layer 130 formed around the conductor 120, the insulation layer 140 formed around the inner semi-conductive layer 130, an outer semi-conductive layer 150 formed around the insulation layer 140, a shield layer 170 formed by winding wires 171 around the outer semi-conductive layer 150, a binding tape layer 180 formed by winding a binding tape 181 around the shield layer 170, and the sheath layer 190 formed around the binding tape layer 180.

The conductor 120 is formed by twisting plural strands together. As the strand, it is possible to use a wire rod, e.g., a tin-plated soft copper wire, etc. The conductor 120 transmits electricity with a high voltage of, e.g., not less than 7000V.

The inner semi-conductive layer 130 and the outer semi-conductive layer 150 are provided to relax electric field concentration, are formed mainly of a polymer-based material, and are formed by extruding a material which is obtained by, e.g., dispersing conductive powder such as carbon in a rubber such as ethylene-propylene rubber, ethylene-vinyl acetate copolymer (EVA) resin or butyl rubber and thus has conductivity.

The insulation layer 140 is formed by extruding a material such as ethylene-propylene rubber, vinyl chloride, cross-linked polyethylene, silicone rubber or fluorine-based material, etc.

The shield layer 170 is formed by spirally winding the wires 171 around the outer semi-conductive layer 150 along the axial direction of the cable. The shield layer 170 is connected to a ground when in use.

The binding tape layer 180 is formed by spirally winding the binding tape 181, with an overlap, around the shield layer 170 along the axial direction of the cable. The binding tape 181 used can be, e.g., a plastic or rayon tape having a thickness of 0.03 to 0.5 mm and a width of 50 to 90 mm.

The sheath layer 190 is formed by extruding a material formed by adding a cross-linking agent, etc., to a rubber such as natural rubber, butyl rubber, halogenated butyl rubber, ethylene-propylene rubber, chloroprene rubber, styrene-butadiene rubber, nitrile rubber, chlorosulfonated polyethylene, chlorinated polyethylene, epichlorohydrin rubber, acrylic rubber, silicone rubber, fluoro-rubber, urethane rubber or halogen-free polyolefin elastomer.

### Connection Method

Next, a method of connecting the power cable 100 to the power cable polymer joint 1 and a method of connecting the power cable polymer joint 1 to the equipment 200 will be described.

Firstly, an end of the power cable 100 is stripped. Next, the compression terminal 3 is connected to the conductor 120 of the power cable 100. Then, the end 101 of the power cable 100 is inserted into the cable insertion hole 2a of the polymer protective layer 2 of the power cable polymer joint 1.

Next, waterproofing process is carried out to seal between the tubular member 23 and the sheath layer 190 of the power cable 100. That is, the waterproof tape 60 is wound around the tubular member 23 at a portion of the outer peripheral surface exposed from the insulation 20 and also around the sheath layer 190 of the power cable 100. At this time, the waterproof tape 60 may be wound around between the inner peripheral surface of the tubular member 23 and the sheath layer 190, as shown in FIG. 1. This allows the power cable 100 to less wobble. Next, the waterproof tape 60 and the periphery thereof are covered with the heat shrinkable tube 61. The waterproofing portion 6 is thereby formed.

After connecting the power cable 100 to the power cable polymer joint 1, the equipment-side conductor 220 of the equipment 200 is inserted into the equipment connection hole 3b of the compression terminal 3 of the power cable polymer joint 1. Next, the nut 7 is tightened onto the male screw 221 of the equipment-side conductor 220 to fix the compression terminal 3 to the equipment-side bushing 210. Next, a drive head of a socket wrench is fitted to the square hole 42a of the insulating plug 4, and the high-voltage electrode 41 of the insulating plug 4 is tightened onto the male screw 221 of the equipment-side conductor 220 by turning the socket wrench. Next, the protective cap 5 is attached to the protective cover 22 by engaging the protrusion 5a of the protective cap 5 with the recess 22a of the protective cover 22. The power cable polymer joint 1 is thereby connected to the equipment 200.

### (Functions and Effects of the Embodiment)

In the present embodiment, the following functions and effects are obtained.

(1) Since the tubular member 23 is integrally formed as a part of the polymer protective layer 2, a component for attaching the tubular member 23 is not required and the weight is thus reduced.

(2) Since the tubular member 23 is formed of a material having good adhesion to the waterproof tape 60, waterproofing is easily maintained by winding the waterproof tape 60 around the tubular member 23 and the power cable 100.

(3) Since the tubular member 23 has the inner diameter larger than the outer diameter of the non-stripped power cable 100, i.e., the outer diameter of the sheath layer 190 and also the first semi-conductive portion 21A has the hole 21a having the inner diameter larger than the outer diameter of the insulation layer 140 in a region overlapping with the tubular member 23 in the cable axis direction, insertability of the power cable 100 into the cable insertion hole 2a is good.

The present invention is not intended to be limited to the embodiment, and the various kinds of embodiments can be implemented. For example, although the joint to be directly connected to equipment has been described in the embodiment, the invention is also applicable to a cable terminal joint and a cable intermediate joint.

In addition, some of the constituent elements in the embodiment can be omitted or changed without changing the gist of the invention. For example, the heat shrinkable tube 61 of the waterproof tape 60 may be omitted.

What is claimed is:

1. A power cable polymer joint, comprising a polymer protective layer comprising a cable insertion hole into which a stripped end of a power cable is inserted,
wherein the polymer protective layer comprises:
an insulation comprising a polymer-based material;
a semi-conductive portion comprising mainly a polymer-based material to relax an electric field at the end of the power cable; and
a tubular member comprising a different material from the polymer-based material and extending on a rear-end side of the insulation and the semi-conductive portion, and
wherein the insulation and the semi-conductive portion and the tubular member are integrally formed.

2. The power cable polymer joint according to claim 1, wherein the end of the power cable is directly connected to equipment.
